(19) United States
(12) Patent Application Publication
(10) Pub. No.: US 2013/0191478 A1
(43) Pub. Date: Jul. 25, 2013

(54) Opinion forming using social networking

(71) Applicant: Michael J. Ure, Cupertino, CA (US)

(72) Inventor: Michael J. Ure, Cupertino, CA (US)

(21) Appl. No.: 13/748,577

(22) Filed: Jan. 23, 2013

Related U.S. Application Data
(60) Provisional application No. 61/589,712, filed on Jan. 23, 2012.

(51) Int. Cl. H04L 12/58

(52) U.S. Cl. CPC H04L 51/32
USPC 709/206

(57) ABSTRACT

Methods are described of ascertaining public opinion using character-limited messages. In one method, a character-limited message is sent from a sender account to each of a plurality of follower accounts seeking a response chosen from among possible responses including multiple predetermined responses. Responses are received including a response from each of multiple follower accounts. The received responses are electronically tabulated to obtain tabulated results. An identical character-limited message may be sent to each of the multiple follower accounts. Alternatively, different character-limited messages may be sent to different ones of the multiple follower accounts. Follow-on character-limited message may also be sent and responses received and tabulated. In effect, choices are “percolated up” to arrive at a collective judgment or opinion.

The present invention relates to social networking.

Microblogging services (e.g., Twitter™) enable rapid, widespread communication of short messages to be performed. Such communications are typically ad hoc and unstructured. While social media has become integrated into web sites in various ways, it would be useful, for example, to use social media in such as way as to enable a competition between Tweets, or messages.

### BRIEF DESCRIPTION OF DRAWING FIGURES

The present invention can be more fully understood from the following description in conjunction with the appended drawing figures. In the drawing:

FIG. 1 is a block diagram of a social networking messaging system.

FIG. 2 is a flow diagram illustrating a first messaging flow.

FIG. 3 is a flow diagram illustrating a second messaging flow.

FIG. 4 is a diagram of a messaging system and a related web page.

### DETAILED DESCRIPTION

### Summary

Methods are described of ascertaining public opinion using character-limited messages. In one method, a character-limited message is sent from a sender account to each of a plurality of follower accounts seeking a response chosen from among possible responses including multiple predetermined responses. Responses are received including a response from each of multiple follower accounts. The received responses are electronically to obtain tabulated results. An identical character-limited message may be sent to each of the multiple follower accounts. Alternatively, different character-limited messages may be sent to different ones of the multiple follower accounts. In the latter instance, a follow-on character-limited message may be sent from a sender account to each of multiple follower accounts seeking a response chosen from among possible responses including multiple predetermined responses, wherein the follow-on character-limited message is one composed taking into account prior tabulated results. Follow-on responses are received including a response from each of multiple follower accounts, and the received follow-on responses are electronically tabulated. In this manner, a large number of choices may be evaluated based on responses and follow-on responses from a large number of follower accounts, where for a given follower account, responses and follow-on responses received from the given follower account pertain to a relatively small number of those choices. In effect, choices are “percolated up” to arrive at a collective judgment or opinion.

### Description

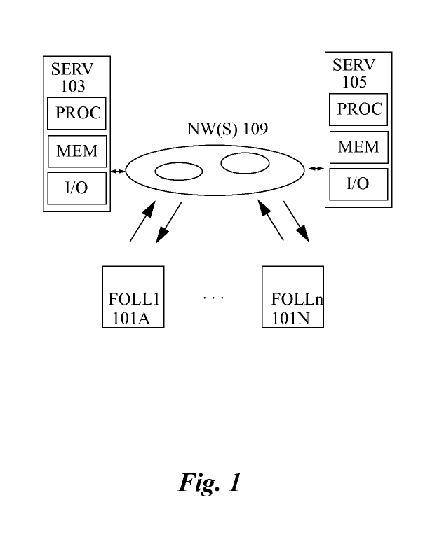

Referring now to FIG. 1, a diagram is shown of a social networking messaging system that may be used for opinion forming. Servers including, for example, a server 103 and a server 105 are coupled to network(s) 109, which may include the internet, wide area networks such as cellular networks, local area networks, etc. The server 103 is a social networking server managed by a social networking service such as Twitter. The server 105 is a messaging server used for opinion forming and manages one or more accounts hosted by the social networking service, e.g., Twitter accounts. The server 105 communicates with the server 103 over the network(s) 109 using, for example, an API of the social networking service, e.g., the Twitter API.

Also connected to the network(s) 109 are devices 101A-101n used in connection with follower accounts. That is, users of the devices 101A-101n are assumed to be followers of one or more of the accounts managed by the server 105.

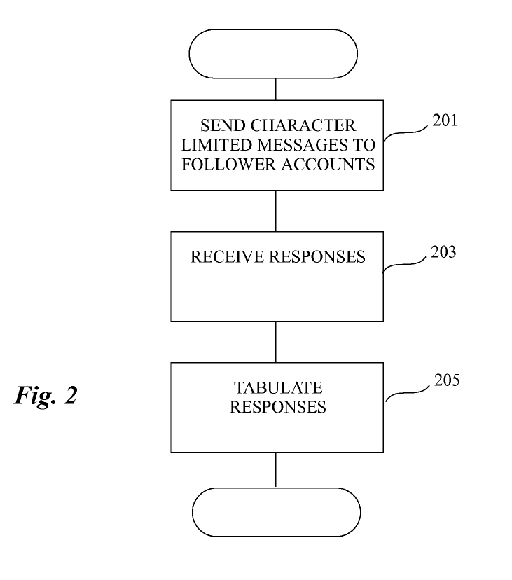

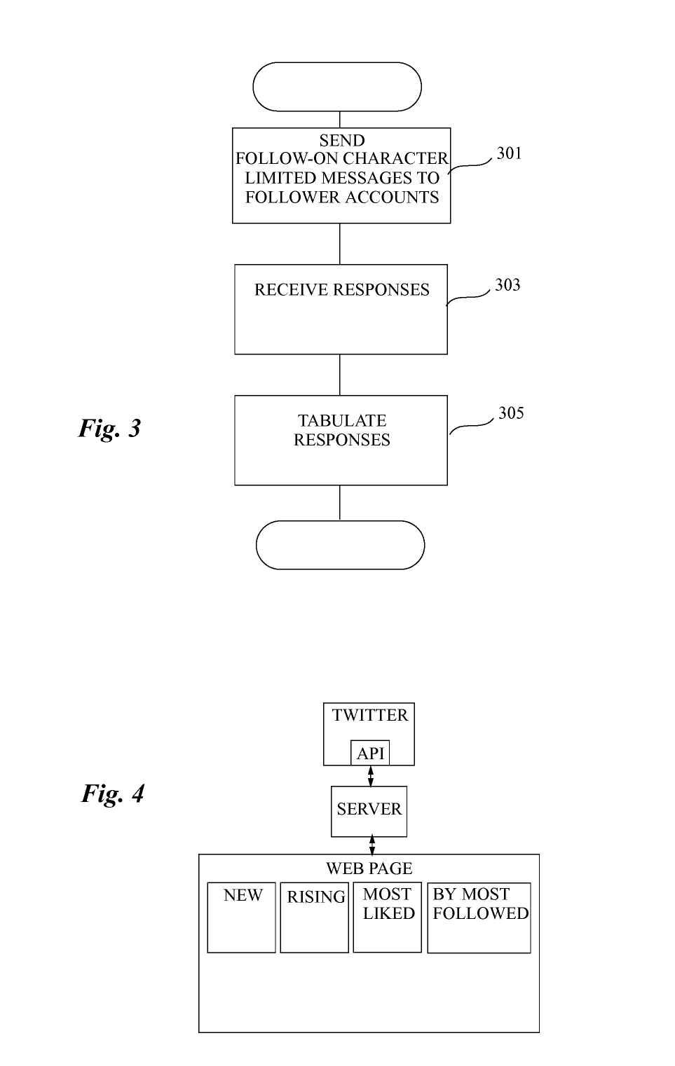

Methods of ascertaining public opinion using character-limited messages are illustrated in FIG. 2 and FIG. 3. Referring to FIG. 2, in one embodiment, in step 201 a character-limited message is sent from a sender account to each of a plurality of follower accounts seeking a response chosen from among possible responses including multiple predetermined responses. In step 203, responses are received including a response from each of multiple follower accounts. In step 205, the received responses are electronically tabulated to obtain tabulated results.

An identical character-limited message may be sent to each of the multiple follower accounts. Alternatively, different character-limited messages may be sent to different ones of the multiple follower accounts. In the latter instance, a follow-on character-limited message may be sent from a sender account to each of multiple follower accounts seeking a response chosen from among possible responses including multiple predetermined responses, wherein the follow-on character-limited message is one composed taking into account prior tabulated results. Follow-on responses are received including a response from each of multiple follower accounts, and the received follow-on responses are electronically tabulated. In this manner, a large number of choices may be evaluated based on responses and follow-on responses from a large number of follower accounts, where for a given follower account, responses and follow-on responses received from the given follower account pertain to a relatively small number of those choices. In effect, choices are “percolated up” to arrive at a collective judgment or opinion.

Replies may be private, preserving anonymity, or may be public, inviting public comment and confirmation of tabulation results. In the case of Twitter, for example, private messaging may be achieved using the direct message feature of Twitter.

For example, a contest may call for character-limited submissions. An entry in the contest may be made by sending a Tweet or other character-limited message containing a particular hashtag or other identifier. Assume that one million submissions are received. The best one or ones of the submissions are to be selected based on the collective judgment of the followers of the account, which may include the submitters. To form such a collective judgment, a manageable number of entries are sent to a larger number of followers. The subset of entries may be the same for some followers but will likely be different for randomly selected followers. Different messages may be sent to different followers using a direct message feature of the social networking service, for example.

Each follower indicates a preference with respect to the subset of entries received by that follower. Responses are tabulated to determine the best submission or submissions. At this point, the collective judgment may or may not be final. The best submission or submissions may move on to a further round of judgment based on the previously tabulated results. Any desired number of rounds may ensue. A given follower may participate in all such rounds or fewer than all. Finally, the best submission or submissions are determined accordingly to the final collective judgment of the followers that participated. A message may be sent to followers informing them of the final tabulated results.

Of course, the same or similar technique may also be applied when the number of submissions, entries, candidates, etc., is small. It may be that all of the choices may be represented in a single character-limited message. In this case, only a single round of opinion forming would take place. When the number of expected submissions is suitably small, each submission may be sent to all followers near the time when the submission was received.

The foregoing methods of ascertaining public opinion may also be performed using a web site. In this instance, choices may be submitted using a microblogging service or via the web site. Social media is integrated with the web site in such a way as to enable a competition between Tweets, or messages. As illustrated in FIG. 4, in one embodiment, a visitor to a website is presented with a selection of “new” Tweets, relatively new to the competition. The user is allowed to indicate like or dislike of the new Tweets, in some instances including a degree of like or dislike. Likes and dislikes of a large number of users are aggregated to determine the “best” or most-liked

Tweets. In some instances, the user may also be presented with a selection of “rising” Tweets—Tweets that have considerable support but have not yet risen to the level of “best.” The user may also be presented with “most followed” Tweets—that is, Tweets submitted by persons having a large number of followers.

It will be appreciated both those skilled in the art that the present invention can be embodied in other specific forms without departing from the spirit or essential character thereof. The described embodiments are therefore intended in all respects to be illustrative and not restrictive. The invention is defined by the appended claims, not by the foregoing description, and all changes which come within the meaning and range of equivalents thereof are intended to be embraced therein.

What is claimed is:

1. A method of ascertaining public opinion, comprising:
electronically sending a character-limited message from a sender account to each of a plurality of follower accounts seeking a response chosen from among possible responses including a plurality of predetermined responses;
electronically receiving received responses including a response from each of a plurality of follower accounts; and
electronically tabulating the received responses to obtain tabulated results.

2. The method of claim 1, wherein electronically sending a character-limited message comprises sending an identical character-limited message to each of the plurality of follower accounts.

3. The method of claim 1, wherein electronically sending a character-limited message comprises sending different character-limited messages to different ones of the plurality of follower accounts.

4. The method of claim 3, comprising:
electronically sending a follow-on character-limited message from a sender account to each of a plurality of follower accounts seeking a response chosen from among possible responses including a plurality of predetermined responses, wherein the follow-on character-limited message is one composed taking into account prior tabulated results;
electronically receiving received follow-on responses including a response from each of a plurality of follower accounts; and
electronically tabulating the received follow-on responses.

5. The method of claim 4, wherein a large number of choices are evaluated based on responses and follow-on responses from a large number of follower accounts, wherein for a given follower account, responses and follow-on responses received from the given follower account pertain to a relatively small number of said choices.
